(19) United States
(12) Patent Application Publication
(10) Pub. No.: US 2005/0154638 A1
(43) Pub. Date: Jul. 14, 2005

(54) Method and apparatus for broadcasting announcements from vehicles

(75) Inventors: Faheem Altaf, Austin, TX (US); Naeem Altaf, Round Rock, TX (US); Jerry Walter Malcolm, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/755,825

(22) Filed: Jan. 12, 2004

(51) Int. Cl. G06F 17/60

(52) U.S. Cl. 705/14

(57) ABSTRACT

A method, apparatus, and computer instructions for broadcasting announcements. A broadcast message is generated, wherein the broadcast message includes sales information for the vehicle with a third party advertisement. The broadcast message is then transmitted from the vehicle using a wireless medium.

### BACKGROUND OF THE INVENTION

1. Technical Field

The present invention relates generally to an improved data processing system and in particular to a method and apparatus for broadcasting messages. Still more particularly, the present invention relates to a method, apparatus, and computer instructions for broadcasting messages from vehicles.

2. Description of Related Art

Advertising is pervasive in today's society. Advertisements may be found in many places. For example, advertisements may be found on billboards, in commercials on television, on Web pages, and even on packaging for goods. In fact, vehicles are often used to announce, make a statement, advertise, or note that they are for sale.

Currently, common practices for advertising on vehicles includes signs mounted in the window, on the top or back of the vehicle, on bumper stickers, decals, or even painting an advertisement on the body of the car. Some of this information is actively sought by others. For example, a person looking to purchase a car may actively seek vehicles with “For Sale” signs in the windows.

In some cases, the person looking to purchase a car may see cars that are not advertised as being for sale. However, almost all cars would be considered to be up for sale if the right price is offered to the owners. Most people, however, would not advertise that fact with a sign in the window.

Therefore, it would be advantageous to have an improved method and apparatus for passing information about a vehicle to interested buyers in a manner that is less invasive than a sign in a window.

### SUMMARY OF THE INVENTION

The present invention provides a method, apparatus, and computer instructions for broadcasting announcements. A broadcast message is generated, wherein the broadcast message includes sales information for the vehicle with a third party advertisement. The broadcast message is then transmitted from the vehicle using a wireless medium.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram illustrating broadcasting of announcements from vehicles in accordance with a preferred embodiment of the present invention;

FIG. 2 is a block diagram of an automotive computing platform in accordance with a preferred embodiment of the present invention;

FIG. 3 is a diagram of a client in the form of a personal digital assistant (PDA) in accordance with a preferred embodiment of the present invention;

FIG. 4 is a block diagram of a PDA in accordance with a preferred embodiment of the present invention;

FIG. 5 is an example of a message broadcast by a vehicle in accordance with a preferred embodiment of the present invention;

FIG. 6 is a diagram of a display of a received message in accordance with a preferred embodiment of the present invention;

FIG. 7 is a flowchart of a process for receiving messages in accordance with a preferred embodiment of the present invention; and

FIG. 8 is a flowchart of a process for creating and transmitting messages in accordance with a preferred embodiment of the present invention.

### DETAILED DESCRIPTION OF THE PREFERRED EMBODIMENT

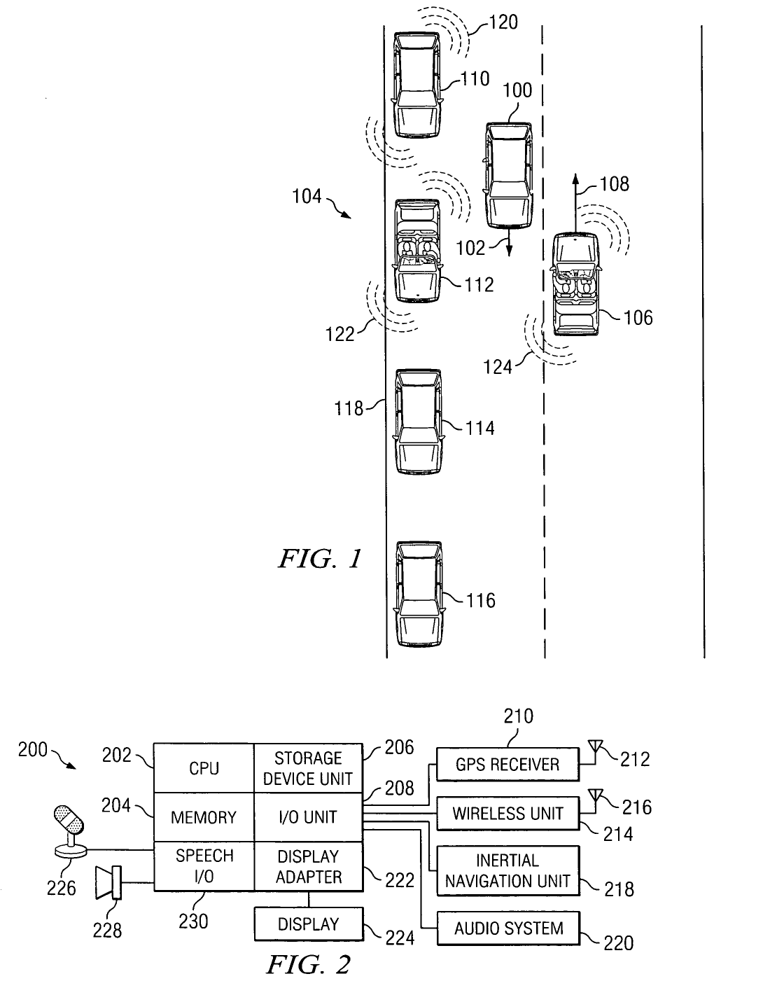

With reference now to the figures, and in particular with reference to FIG. 1, a diagram illustrating broadcasting of announcements from vehicles is depicted in accordance with a preferred embodiment of the present invention. In this illustrative example, automobile 100 is traveling along the direction of arrow 102 on road 104 while automobile 106 is traveling in the direction of arrow 108. Automobiles 110, 112, 114, and 116 are parked along side 118 of road 104.

The present invention provides a method, apparatus, and computer instructions for broadcasting messages from vehicles, such as the automobiles illustrated in FIG. 1. In these illustrative examples, the messages are broadcasted using a wireless technology to indicate that a particular automobile is for sale. Such a mechanism is less invasive than posting a sign in the window of an automobile.

For example, a buyer in automobile 100 may obtain messages from transmissions 120, 122 and 124 in these examples. These transmissions originate from automobiles 110, 112, and 106, respectively. No transmissions are made by automobile 114 or automobile 116 in this example. These vehicles are not enabled for transmissions or are not being offered for sale.

In the illustrative embodiments, the wireless transmissions from the automobiles are short-range transmissions. These short-range transmissions may take various forms, such as, for example, very low power radio frequency (RF), wireless fidelity (Wi-Fi), and Bluetooth. Wi-Fi refers to a set of I.E.E.E. standards, 802.11a and 802.11b, for wireless transmissions. Bluetooth is a wireless personal area network (PAN) technology from the Bluetooth Special Interest Group. Bluetooth is an open standard for short-range transmission of digital voice and data between mobile devices (laptops, personal digital assistants (PDAs), phones) and desktop devices. This standard supports point-to-point and multipoint applications.

These transmissions are received at automobile 100 by the potential buyer. The transmissions may be received through a data processing system built into automobile 100. Alternatively, these transmissions may be received by a portable device carried by the potential buyer, such as, for example, a PDA or a mobile phone. The potential buyer in automobile 100 may view the information as messages are gathered from the different automobiles along road 104. Additionally, this information may be saved for later use and analysis.

The messages transmitted by the automobiles includes sales information. This information includes, for example, a sale price for the automobile, make, model, paint code, current mileage and contact information may be included in the message. In this manner, a buyer may simply drive down a road, such as road 104 and collect information on vehicles in the vicinity. Additionally, this information may be collected from any location where vehicles are found. A buyer may drive through a parking lot or parking garage to obtain information.

Further, advertisements from third parties may be embedded in messages broadcast by automobiles 110, 112, and 106. These advertisements may be from any third party, including a car dealer. A potential seller may permit this advertising in exchange for different types of compensation. For example, an advertiser may pay the car owner money, provide discount service arrangements, or other types of incentives.

Turning next to FIG. 2, a block diagram of an automotive computing platform is depicted in accordance with a preferred embodiment of the present invention. Computing platform 200 is located within a vehicle, such as vehicle 100 in FIG. 1. Computing platform 200 includes a CPU 202, which may be an embedded processor or a processor, such as a Pentium processor from Intel Corporation. “Pentium” is a trademark of Intel Corporation. Computing platform 200 also includes memory 204 which may take the form of random access memory (RAM) and/or read-only memory (ROM).

Computing platform 200 also contains a storage device unit 206. Storage device unit 206 may contain one or more storage devices, such as, for example, a hard disk drive, a flash memory, a DVD drive, or a floppy disk. Computing platform 200 also includes an input/output (I/O) unit 208, which provides connections to various I/O devices. In this example, a GPS receiver, such as GPS receiver 210, is included within computing platform 200 and receives signals through antenna 212.

Wireless unit 214 provides for two-way communications between computing platform 200 and another data processing system. This communication may be established using TCP/IP protocols normally found on the Internet. Communications are provided through antenna 216. These communications may take various forms, such as, RF signals, Wi-Fi, and Bluetooth.

In addition, inertial navigation unit 218 is connected to I/O unit 208. Inertial navigation unit 218 is employed for navigation when GPS receiver 210 is unable to receive a usable signal or is inoperable.

Audio system 220 also is connected to I/O unit 208. Audio system 220 includes a radio that may be tuned to various radio stations via different mediums. Audio system 220 also may include other components, such as a CD-ROM player or an MP3 device. Audio system 220 may receive broadcasts from a variety of mechanisms. For example, audio system 220 may receive broadcasts via traditional airway broadcasts, such as AM or FM broadcasts, or satellite radio broadcasts. These traditional airway broadcasts are typically analog broadcasts, while the satellite radio broadcasts are digital ones. Also, audio system 220 may receive Internet broadcasts by tuning or connecting to IP addresses for desired radio stations. Internet connections may be established using any wireless connection system for Internet access. In these examples, dynamic tuning in audio system 220 may be controlled through CPU 202.

Computing platform 200 also includes a display adapter 222, which is connected to display 224. In the depicted example, this display is a touch screen display. Alternatively or in addition to a touch screen display, display 224 also may employ a heads-up display projected onto the windshield of the automobile. Computing platform 200 also includes a microphone 226 and a speaker 228 to provide a driver with the ability to enter commands and receive responses through speech I/O 230 without having to divert the driver's attention away from the road, or without the driver having to remove the driver's hands from the steering wheel.

In these examples, computer instructions may be included for execution by CPU 202 to provide transmission of messages containing possible offers for sale, and other information.

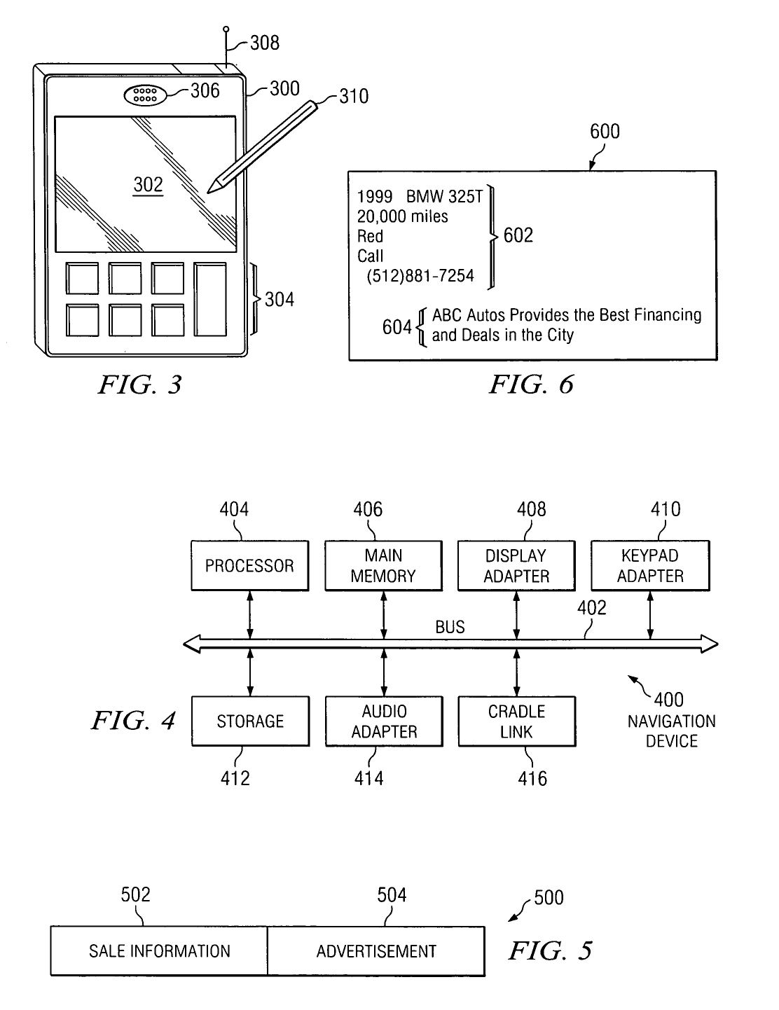

With reference now to FIG. 3, a diagram of a client in the form of a personal digital assistant (PDA), is depicted in accordance with a preferred embodiment of the present invention. PDA 300 includes a display 302 for presenting textual and graphical information. Display 302 may be a known display device, such as a liquid crystal display (LCD) device. The display may be used to present a map or directions, calendar information, a telephone directory, or an electronic mail message. In these examples, screen 302 may receive user input using an input device such as, for example, stylus 310.

PDA 300 may also include keypad 304, speaker 306, and antenna 308. Keypad 304 may be used to receive user input in addition to using screen 302. Speaker 306 provides a mechanism for audio output, such as presentation of an audio file. Antenna 308 provides a mechanism used in establishing a wireless communications link between PDA 300 and a network, such as network 202 in FIG. 2.

PDA 300 also preferably includes a graphical user interface that may be implemented by means of systems software residing in computer readable media in operation within PDA 300.

Turning now to FIG. 4, a block diagram of a PDA, is shown in accordance with a preferred embodiment of the present invention. PDA 400 is an example of a PDA, such as PDA 400 in FIG. 4, in which code or instructions implementing the processes of the present invention may be located. PDA 400 includes a bus 402 to which processor 404 and main memory 406 are connected. Display adapter 408, keypad adapter 410, storage 412, and audio adapter 414 also are connected to bus 402. Cradle link 416 provides a mechanism to connect PDA 400 to a cradle used in synchronizing data in PDA 400 with another data processing system. Further, display adapter 408 also includes a mechanism to receive user input from a stylus when a touch screen display is employed.

An operating system runs on processor 404 and is used to coordinate and provide control of various components within PDA 400 in FIG. 4. The operating system may be, for example, a commercially available operating system such as Windows CE, which is available from Microsoft Corporation. Instructions for the operating system and applications or programs are located on storage devices, such as storage 412, and may be loaded into main memory 406 for execution by processor 404.

Those of ordinary skill in the art will appreciate that the hardware in FIG. 4 may vary depending on the implementation. Other internal hardware or peripheral devices, such as flash ROM (or equivalent nonvolatile memory) or optical disk drives and the like, may be used in addition to or in place of the hardware depicted in FIG. 4.

With reference now to FIG. 5, an example of a message broadcast by a vehicle, is depicted in accordance with a preferred embodiment of the present invention. As illustrated, message 500 includes sale information 502 and advertisement 504. Sales information 502 contains information about the vehicle. This information includes, for example, the sale price, make, model, year, color, paint code, mileage, and contact information. The contact information may be a phone number or an e-mail address for the seller or broker.

Advertisement 504 is an advertisement from a third party. This advertisement may be, for example, from a car dealer, a restaurant, an airline, or any other entity. In these illustrative examples, advertisement 504 can not be changed or deleted without a password. This password is set by the advertiser in these examples to prevent an automobile owner from deleting advertisement 504. Alternatively, the password may be set by a party other than the car owner or the advertiser. The password would then be provided to the car owner when the agreement or period of time for the advertisement has expired.

With reference next to FIG. 6, a diagram of a display of a received message, is depicted in accordance with a preferred embodiment of the present invention. Display 600 is an example of a display provided by display 224 in computing platform 200 in FIG. 2 or by display 302 in PDA 300 in FIG. 3.

In display 600, section 602 provides sales information, such as sales information 502 in FIG. 5. As depicted, section 602 presents the year, model, make, mileage, and color of the vehicle for sale. Additionally, contact information is provided in section 602. Next, section 604 includes an advertisement for a car dealer. Although the advertisement and information is illustrated only with text, other formats and media may be used. For example, graphics and animations could be included in the advertisement or sales information, depending on the amount of data that is to be transmitted in the message. Further, the message also could include audio or voice.

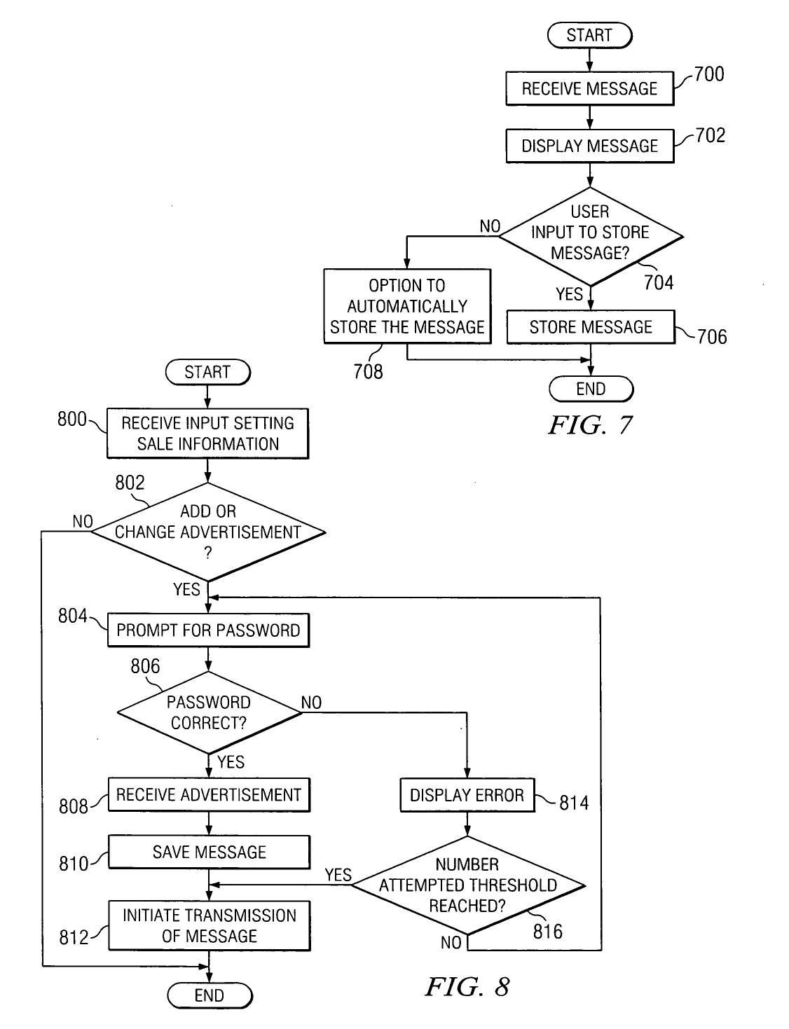

Turning next to FIG. 7, a flowchart of a process for receiving messages, is depicted in accordance with a preferred embodiment of the present invention. The process illustrated in FIG. 7 may be implemented in a device, such as computing platform 200 in FIG. 2 or in PDA 300 in FIG. 3.

The process begins by receiving a message broadcast from a vehicle (step 700). Thereafter, the message is displayed (step 702). A determination is then made whether a user input is received to store the message (step 704). In some cases, a user may decide to store one or more messages for later viewing or analysis. This determination may be made through a user input selecting the message for storage. If the message is to be stored, the message is then stored in the device (step 706) with the process terminating thereafter.

With reference again to step 704, if a user input to store the message is not received, a determination is made as to whether an option has been set to automatically store the message (step 708). Alternatively, the user may set an option to automatically store messages. Further, the storage of messages may be selected based on the presence of key words in the message. If an option has been set, the process proceeds to step 706 as described above. Otherwise, the process terminates without storing the message.

With reference now to FIG. 8, a flowchart of a process for creating and transmitting messages, is depicted in accordance with a preferred embodiment of the present invention. The process illustrated in FIG. 8 may be implemented in an automobile using computing platform 200 in FIG. 2.

The process begins by receiving input setting sales information (step 800). This information may be entered by a user or owner of the automobile. Next, a determination is made as to whether an advertisement is to be added or changed (step 802). If an advertisement is to be added or changed, a prompt is made for entry of a password (step 804). A determination is made as to whether the password entered is correct (step 806). If the password is correct, the advertisement is then received (step 808). In these illustrative examples, the password required to open a message to add an advertisement is one that belongs to the owner of the automobile. The password needed to change or delete an advertisement from a message is one that is generated and known by the advertising party, such as the car dealer. Further, each advertisement included in a message may have a different password for a different advertising party. As a result, multiple advertisements may be included in a message from different advertisers. For example, dealer A may place a first advertisement in the message and protect it with a password. Dealer B may add a second advertisement to the message and protect the second advertisement with a password known to dealer B.

A determination is made as to whether the password entered is correct (step 806). If the password is correct, the advertisement is then received (step 808). The information for the advertisement may be received from the advertiser through a wireless connection, such as one over the Internet. The message information is then saved (step 810), and transmission of the message is initiated (step 812) with the process terminates thereafter.

With reference again to step 806, if the password is incorrect, an error is displayed (step 814). Then, a determination is made as to whether the number of attempts is greater than a threshold (step 816). This step is employed for security reasons to prevent someone from trying numerous combinations of passwords. If the threshold has not been exceeded, the process returns to step 804. Otherwise, the process proceeds to step 812 as described above. With reference again to step 802, if the user input is not to add or change an advertisement, the process terminates.

In this manner, the present invention provides an improved method, apparatus, and computer instructions for broadcasting messages from a vehicle. The messages broadcast in these illustrative examples include an offer to sell the vehicle as well as an advertisement from a third party. As a result, some car owners who would not display signs in their cars may be willing to offer their cars for sale with this less intrusive mechanism. Also, the mechanism of the present invention is applicable to vehicles other than just automobiles. For example, the mechanism of the present invention may be used with offering trucks, sport utility vehicles, motorcycles, and boats for sale.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in an automotive data processing system for broadcasting announcements, the method comprising:
generating a broadcast message, wherein the broadcast message includes sales information for the vehicle with a third party advertisement; and
transmitting the broadcast message from the vehicle using a wireless medium.

2. The method of claim 1, wherein the advertisement is changeable only with a password.

3. The method of claim 1, wherein the sales information in the broadcast message includes at least one of sales price, make, model, paint code, current mileage, contact phone number, and contact email address.

4. The method of claim 1, wherein the vehicle is selected from one of an automobile, a truck, a sport utility vehicle, or a motorcycle.

5. The method of claim 1, wherein the third party advertisement is an advertisement for an automobile dealer or some other business.

6. The method of claim 1, wherein the wireless medium is at least one of Wi-Fi, BlueTooth, and radio frequency.

7. An automotive data processing system for broadcasting announcements, the data processing system comprising:
generating means for generating a broadcast message, wherein the broadcast message includes sales information for the vehicle with a third party advertisement; and
transmitting means for transmitting the broadcast message from the vehicle using a wireless medium.

8. The data processing system of claim 7, wherein the advertisement is changeable only with a password.

9. The data processing system of claim 7, wherein the sales information in the broadcast message includes at least one of a sale price, make, model, paint code, current mileage, contact phone number, and contact email address.

10. The data processing system of claim 7, wherein the vehicle is selected from one of an automobile, a truck, a sport utility vehicle, or a motorcycle.

11. The data processing system of claim 7, wherein the third party advertisement is an advertisement for an automobile dealer.

12. The data processing system of claim 7, wherein the wireless medium is at least one of Wi-Fi, BlueTooth, and radio frequency.

13. A computer program product in a computer readable medium in an automotive data processing system for broadcasting announcements, the computer program product comprising:
first instructions for generating a broadcast message, wherein the broadcast message includes sales information for the vehicle with a third party advertisement; and
second instructions for transmitting the broadcast message from the vehicle using a wireless medium.

14. The computer program product of claim 13, wherein the advertisement is changeable only with a password.

15. The computer program product of claim 13, wherein the sales information in the broadcast message includes at least one of a sale price, make, model, paint code, current mileage, contact phone number, and contact email address.

16. The computer program product of claim 13, wherein the vehicle is selected from one of an automobile, a truck, a sport utility vehicle, or a motorcycle.

17. The computer program product of claim 13, wherein the third party advertisement is an advertisement for an automobile dealer.

18. The computer program product of claim 13, wherein the wireless medium is at least one of Wi-Fi, BlueTooth, and radio frequency.
